(19) United States
(12) Patent Application Publication
(10) Pub. No.: US 2004/0174890 A1
(43) Pub. Date: Sep. 9, 2004

(54) Network switch chip and method for cascading the same

(76) Inventors: Murphy Chen, Hsin Tien City (TW); Sharon Huang, Hsin Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/377,608

(22) Filed: Mar. 4, 2003

(51) Int. Cl. H04L 12/28

(52) U.S. Cl. 370/402

(57) ABSTRACT

A network switch chip and a method for controlling the same are proposed. A first network switch chip is cascaded with a second network switch chip. Each of the network switch chip comprises a high-speed network port and a plurality of connection ports. The two network switch chips are connected through the two high-speed network ports to form a direct link therebetween, and the network switch provides a transmission rate equal to the sum of transmission rates of the first connection ports and the second connection ports. The two network switch chips can update an operation status for each other through the direct link and whereby the first network switch chip and the second network switch can manage data exchange therebetween. Each of the network switch chips has a lookup table therein and the network switch chips can update the lookup table for each other.

### FIELD OF THE INVENTION

The present invention relates to a network switch chip and a method for cascading the same, more particularly, the present invention relates to a network switch chip connected to another network switch chip through a high-speed network port such that the cascaded network switch chips are capable of providing more connection ports with high performance.

### BACKGROUND OF THE INVENTION

Conventionally, the workstations and servers in a local area network (LAN) are generally connected through twisted-pair cables centralized at an Ethernet hub to share resource thereof. However, as the number of linked workstations and servers are increased, the problem of collision becomes more serious.

A switch is developed to perform flow control and improve data throughput. The switch uses lookup table approach to learn addresses by associating the hardware addresses of connected stations with the ports thereof. When a hardware address to be accessed is not present at the lookup table due to age out or other reasons, the switch can broadcasts the associated packet and updates the lookup table while said packet is successfully received.

In a switch, the maximum number of linked stations is depended on the port number thereof and therefore is limited. To solve this problem, two or more switches are cascaded to increase the port number. However, some problems still occur in this situation. First, the cascaded stations cannot share the information of congestion status. As a result, the transmission data may be corrupted and the efficiency of the switch is deteriorated. Secondly, the destination address may be acquired by repeatedly table lookup operations, hence the transmission efficiency is lowered.

### SUMMARY OF THE INVENTION

It is the object of the present invention to provide a network switch chip connected to another network switch chip through high-speed network ports thereof for achieving direct link therebetween. Therefore, the cascaded network switch chips can share congestion information between each other. The destination address of a packer sent to a network switch chip can be automatically copied to other network switch chip cascaded to the network switch chip. Therefore, the other network switch chip does not need to check the lookup table again for finding destination address. The packet transmission rate is ensured and the cascade of network switch chips has enhanced effect.

To achieve above object, the present invention provides a network switch chip and a method for cascading the same. A first network switch chip is cascaded with a second network switch chip. Each of the network switch chip comprises a high-speed network port and a plurality of connection ports. The first network switch chip and the second network switch chip are connected through the first and second high-speed network port to form a direct link therebetween. At the same time, the network switch provides a transmission rate to the sum of transmission rates of the first connection ports and the second connection ports. The first network switch chip and the second network switch chip update an operation status for each other through their direct link and whereby the first network switch chip and the second network switch can manage data exchange therebetween.

The various objects and advantages of the present invention will be more readily understood from the following detailed description when read in conjunction with the appended drawing, in which:

### BRIEF DESCRIPTION OF THE DRAWING

FIG. 1 shows the network switch chips according to one embodiment of the present invention;

FIG. 2 shows a block diagram of the network switch chip;

FIG. 3 shows the block diagram of the network switch according to one embodiment of the present invention;

FIG. 4 shows the block diagram according to one embodiment of the present invention;

FIG. 5 shows a schematic view of the lookup table according to one embodiment of the present invention.

### DETAILED DESCRIPTION OF THE INVENTION

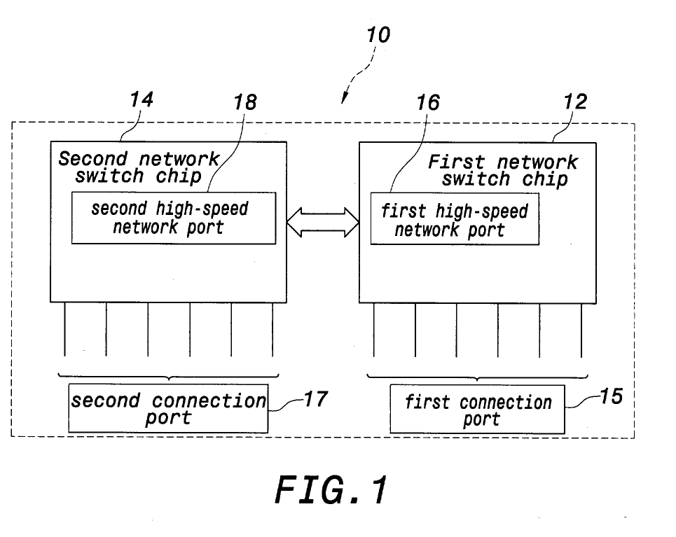

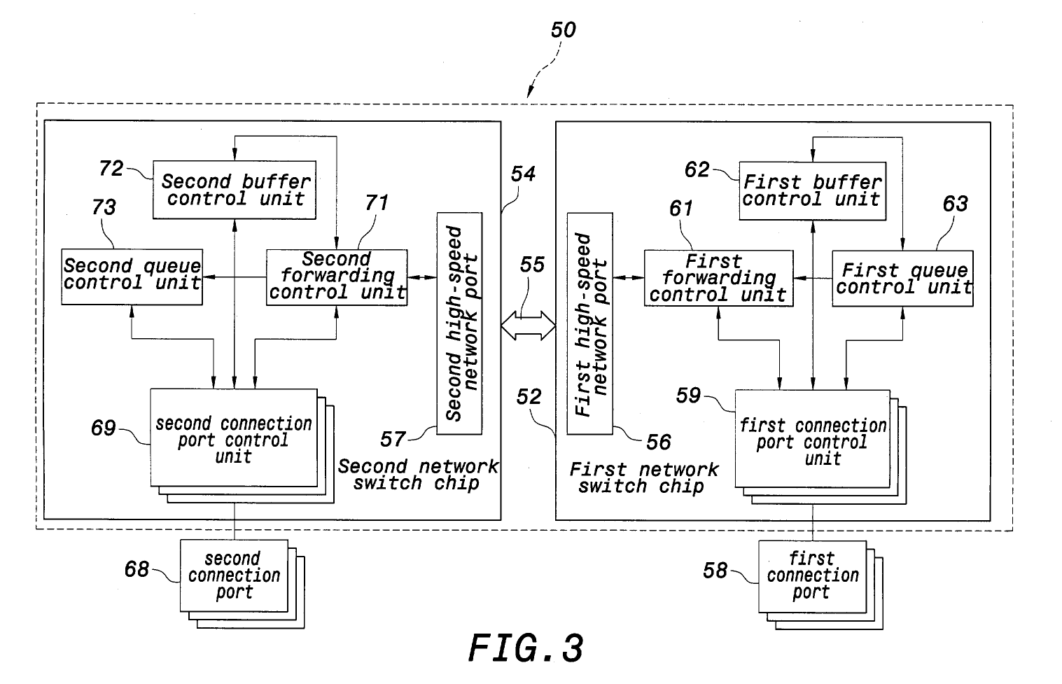

FIG. 1 shows a network switch chip 10 according to one embodiment of the present invention, which comprises a first network switch chip 12 and a second network switch chip 14. The first network switch chip 12 comprises a plurality of first connection ports 15 connected to external stations or other switches, and a first high-speed network port 16. The second network switch chip 14 comprises a plurality of second connection ports 17 connected to external stations or other switches, and a second high-speed network port 18 directly connected to the first high-speed network port 16 to establish a direct link 55 (FIG. 3) therebetween. Therefore, the first network switch chip 12 and the second network switch chip 14 are directly connected through the connection of the first high-speed network port 16 and the second high-speed network port 18 and share operation status to each other. Moreover, the data coming from the first connection ports 15 of the first network switch chip 12 can be output through the second connection ports 17 of the second network switch chip 14, and vice versa.

The operation status of the first network switch chip 12 and the second network switch chip 14 comprises, for example, congestion condition in every port thereof. The first network switch chip 12 and the second network switch chip 14 can share the congestion condition through the connection of the first high-speed network port 16 and the second high-speed network port 18. For example, once a connection port (in the first connection ports 15 or the second connection ports 17) congests, the first network switch chip 12 or the second network switch chip 14 stops the data transmission from the source port toward the congested port, in other words the first network switch chip 12 and the second network switch chip 14 can send a command or a control packet to stop data transmission to the congested port until the congestion is relieved.

The data transmission rate between the first high-speed network port 16 and the second high-speed network port 18 is preferably larger than the sum of maximal data transmission rates of the first connection ports 15 and the second connection ports 17 to avoid blockage problem when the second high-speed network port 18 and the second connection ports 17 are used to send data received from the first connection ports 15, or vice versa.

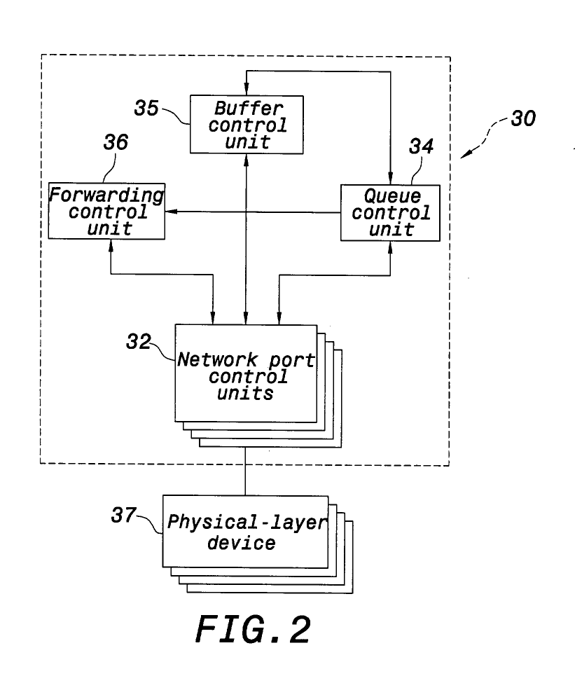

FIG. 2 shows a block diagram resemble the process of network switch chip 30. As shown in this figure, the network switch chip 30 comprises a plurality of network port control units 32, a queue control unit 34, a buffer control unit 35 and a forwarding control unit 36. The plurality of network port control units 32 is connected to a plurality of physical-layer devices 37 communicating with external stations for transiting packers.

The queue control unit 34 is connected to the network port control units 32, the buffer control unit 35 and the forwarding control unit 36. Moreover, each of the network port control units 32 associates with an output queue (not shown) in the queue control unit 34. The queue control unit 34 establishes links to the output queue according to the requests of the port control unit 32. In case that one or more port is congested, the network switch chip 30 stops the data coming from external stations or switches. The buffer control unit 35 is connected to the network port control units 32 and used to allocate buffers or free buffers according to the requests of the network port control units 32. The forwarding control unit 36 is coupled to the network port control units 32 and used to perform table lookup according to the header in a packet to determine the destination port(s).

When the congestion occurs, the network switch chip 30 determines a flow control approach according to the operation mode and the flow control ability of the station connected to the physical layer 37. The flow control approaches include the full duplex flow control; drop control and backpressure control. When the stations or switches connected to the physical-layer devices 37 (source ports) have full duplex ability, the network switch chip 30 performs flow control. In the drop control approach, the data packets should be dropped at the source ports due to congestion. In the backpressure control approach, the network switch chip 30 can send a collision signal to crash the data packet.

FIG. 3 shows the block diagram of the network switch 50 according to the present invention. The network switch 50 according to the present invention comprises a first network switch chip 52 and a second network switch chip 54. The first network switch chip 52 has a first high-speed network port 56 and the second network switch chip 54 has a second high-speed network port 57 such that the first network switch chip 52 and the second network switch chip 54 are cascaded through the connection of the first high-speed network port 56 and the second high-speed network port 57. The first network switch chip 52 further comprises a plurality of first connection ports 58, a plurality of first connection port control units 59 corresponding to the first connection ports 58, a first forwarding control unit 61 connected to the first connection port control units 59 and the first high-speed network port 56, a first buffer control unit 62 connected to the first connection port control units 59, and a first queue control unit 63 connected to the first connection port control units 59, the first forwarding control unit 61 and the first buffer control unit 62 for providing en-queue or de-queue services for those units.

The first connection port control units 59 respectively associate with a plurality of output queues (not shown) in the first queue control unit 63 and the first queue control unit 63 establishes links to the output queue according to the requests of the first connection port control units 59. In case that one or more output queue is congested, the first network switch chip 52 stops the data transmission from external stations or switches to the congested port. The first buffer control unit 62 is connected to the first connection port control units 59 and used to allocate buffers or free buffers in response to the requests of the first connection port control units 59. The first forwarding control unit 61 performs table lookup according to the header of a packet received by the first connection port control units 59 to determine the destination port.

The second network switch chip 54 further comprises a plurality of second connection ports 68, a plurality of second connection port control units 69 corresponding to the second connection ports 68, a second forwarding control unit 71 connected to the second connection port control units 69 and the second high-speed network port 57, a second buffer control unit 72 connected to the second connection port control units 69, and a second queue control unit 73 connected to the second connection port control units 69, the second forwarding control unit 71 and the second buffer control unit 72. Each of the second connection ports 68 is connected to an external station or a switch for transceiving data packets. The first connection ports 58 and the second connection ports 68 can transceive data packets via external stations, switches, and the other cascaded network switch chip. For example, the data received from the first connection ports 58 of the first network switch chip 52 can be output through the second connection ports 68 of the second network switch chip 54, and vice versa.

The first high-speed network port 56 is directly connected to the second high-speed network port 57 to establish a direct link 55 between the first network switch chip 52 and the second network switch chip 54. The direct link 55 can be implemented as a bi-directional bus and with a bandwidth preferably larger than the sum of maximal data transmission rates of the first connection ports 58 and the second connection ports 68 to prevent blocking problem. By the direct link 55, the network switch 50 can manage the packet switching and update the operation status for the first network switch chip 52 and the second network switch chip 54.

The operation status for the first network switch chip 52 and the second network switch chip 54 preferably includes the congestion information for the first connection ports 58 and the second connection ports 68 and the content of lookup tables in the forwarding control units 61 and 71. The network switch chips 52 and 54 may perform congestion control according to the congestion information of destination port. The second network switch chip 54 learns the congestion information of the first connection ports 58 through the direct link 55 and stop sending data packet to the destination addresses associated with the congested ports in the first network switch chip 52. On the other hand, the first network switch chip 52 learns the congestion information in second connection ports 68 through the direct link 55 and stop sending data packet to the destination addresses associated with the congested ports in the second network switch chip 54.

A data packet contains a source MAC address and a destination MAC address. If the destination MAC address can not be identified by lookup table, the data packet is broadcasted to all other ports. In the network switch of the present invention, the first network switch chip 52 and the second network switch chip 54 can update the content of the lookup table for each other. For example, if the first network switch chip 52 has data to be sent to the second network switch chip 54 through the first high-speed network port 56 and the second high-speed network port 57 and the first network switch chip 52 knows the destination address is associated with one or more of the eight ports at the remote side (i.e. the second network switch chip 54) from its lookup table, it is not necessary for the second network switch chip 54 to perform table look up again. Therefore, the operation efficiency of the network switch 50 is enhanced.

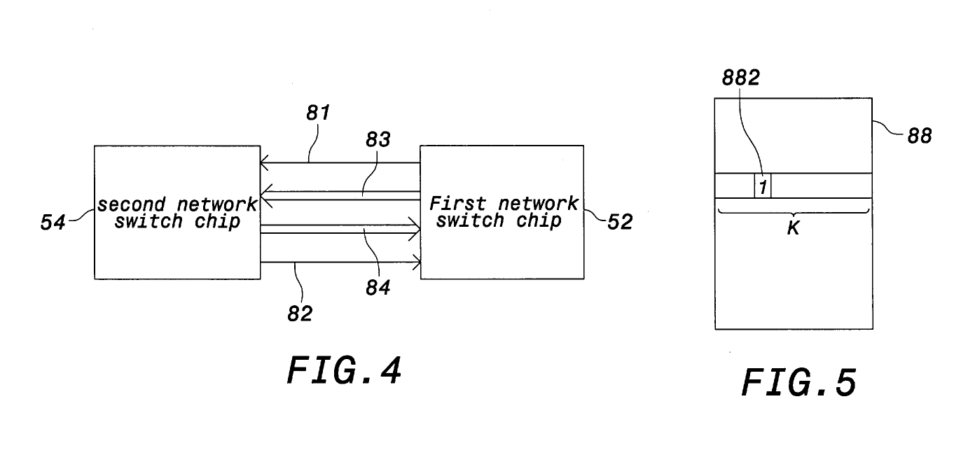

FIG. 4 shows a preferred embodiment of the present invention, wherein the first network switch chip 52 is connected to the second network switch chip 54 through signal lines 81, 82 and buses 83, 84 as the direct link 55. The first network switch chip 52 can send data packets or commands to the second network switch chip 54 through the buses 83 and 84, and the signal lines 81, 82 can be used to discriminate whether the current signal is a data packet, or a command for remote party.

The operation efficiency of the network switch is enhanced by real-time commanding the remote party. For example, the buses 83, 84 are exemplified by 16-bit (a word) bus and used to transmit data packets or commands to the remote party for the first network switch chip 52 and the second network switch chip 54. The buses 83, 84 have data transmission rate preferably larger than the sum of maximal data transmission rates of the first connection ports 58 and the second connection ports 68 to prevent blocking problem. The signals transmitted in the signal lines 81, 82 are defined as command bits to determine the signal type (data packet or command) on the buses 83, 84.

TABLE 1

| command bit | bus signal [15:0] | command or data |
|---|---|---|
| 1 | 1111-1111-1111-1111 | idle command |
| 1 | 0000-0000-0000-0000 | start of frame (SOF) |
| 0 | link word 0, link word | after SOF, first two words indicating packet |
| | 1 packet word 0, 1, . . ., N | length N and port number and followed by |
| | | packer data |
| 1 | 0010-0000-0000-0000 | intra-packet gap command |
| 1 | 0000-00yx-xxxx-xxxx | flow control status report |
| | | x [8:0] congestion information of the ports |
| | | y: broadcast report |
| 1 | 0110-00xx-xxxx-xxxx | learning address command; |
| | 0110-yyyy-yyyy-yyyy | x [9:0]: item index of the lookup table to be |
| | 0110-yyyy-yyyy-yyyy | learned; |
| | 0110-yyyy-yyyy-yyyy | y [46:0]: the tag and the connection port |
| | 0110-yyyy-yyyy-yyyy | number of the learned MAC address; |
| 1 | 1000-00xx-xxxx-xxxx | age out command; |
| | 100y-yyyy-yyyy-yyyy | x [9:0]: the item index to be updated; |
| | 100y-yyyy-yyyy-yyyy | y [37:0]: tag in the MAC address to be |
| | 100y-yyyy-yyyy-yyyy | updated; |

As shown in Table 1, the first column shows a field of the command bit. If the command bit on the signal line 81 is 1, the 16-bit data on the bus 83 are used as a command. When the command bit on the signal line 81 is 0, the 16-bit data on the bus 83 are determined as data packet. Same definition is applied to the signal line 82 and bus 84.

The second column in Table 1 denotes bus signal [15:0] and the binary values in bus signal can be assigned with various signal patterns for various command types, which should be noted by the skilled in the art.

The third column in Table 1 denotes various command types corresponding to the signal patterns shown in the second column. For example, when there is no data to be transmitted through the bus 83, the first network switch chip 52 sends the idle command through the bus 83 (command bit=1) and the idle command has signal pattern [1111-1111-1111-1111], as shown in the first row. When the first network switch chip 52 has data to be sent to the second network switch chip 54, the first network switch chip 52 sends SOF (start of frame) command to the second network switch chip 54 through the bus 83 (command bit=1) and the SOF command has signal pattern [0000-0000-0000-0000], as shown in the second row. Afterward, the command bit is changed to 0 representing data transmission. The data signal sent through the bus 83 comprises two link words and succeeding packet data, wherein the two link words preferably represent data length N and port associated with the destination address. Preferably, the table lookup is performed locally in only one switch chip. The signal pattern shown in the fourth row is [0010-0000-0000-0000] to represent an intra-packet gap command. The intra-packet gap command prevents exhausting buffers and data loss. This may happen at high-speed port such as Giga port, which has higher speed than data to be sent. The signal in the fifth row is flow control status report used to inform the remote chip about the flow control status of ports at the local chip. Moreover, the flow control status report can directly send to the remote chip while transmitting the above packet data, in case the data packets are informed to the remote chip in advance. The remote chip already knew the number of data packets and hence the flow control status report can be sent to the remote chip in real-time without causing data disorder. In this embodiment, the signal pattern of the flow control status report is [0100-00yx-xxxx-xxxx-xxxx], whereby the congestion information of the ports (up to 9 ports) in the local chip are manifested by the data x of 9 bit. The bit y indicates whether or not the status report is a broadcast report. The broadcast packet occupies considerable bandwidth. Therefore, the two cascaded network chips can know the broadcast congestion of other party by the broadcast report bit y. Once the broadcast congestion occurs in the local chip, the remote network chip stops sending any broadcast packet to the local chip or issues delay frames to temporarily stop sending data to congested ports. A plurality of status bits can be implemented by flip-flops or latches, such that the remote chip set up operation modes accordingly. The signal in the sixth row indicates a learning address command used to share the learned address with the cascaded chip. As shown in this table, the learning address command comprises data x at [9:0] to indicate the item index of the lookup table to be updated and the data y at [46:0] to indicate the tag and the port number associate with the learned MAC address.

FIG. 5 shows a schematic view of the lookup table 88, which is a dual slot table. The 48-bit MAC address can be transformed to an index k by hash operation. The tag value (less than 48 bits, for example, being 38 bits) of the 48-bit MAC address and the associated port number are saved in the location of the lookup table 88 labeled by the index k. The tag value is identified to be associated with a specific network chip by a remote identification bit 882. Therefore, the data structure of the lookup table 88 in each network chip can be simplified. For example, the first network switch chip 52 can obtain an MAC address from an index k in the lookup table 88 thereof, and know that the port number associates with a remote network chip (i.e., the second network chip 54) cascaded thereto because the identification bit 882 is 1. Therefore, the first network switch chip 52 can quickly identify the destination port(s) of the second network chip 54, and informs the second network chip the port number by the first two link words.

The last row in Table 1 is used to indicate the age out command with signal pattern [1000-00xx-xxxx-xxxx]. The data x [9:0] in the first word denotes the index to be updated in a lookup table. The following three words use y [37:0] to denote the tag to be updated without requiring the port number. In the preferred embodiment of the present invention, the aged-out MAC address can be deleted by knowing the hash value x [9:0] and the tag y [37:0] according to the age out command. As apparent to the skilled in the art, the MAC address can be uniquely determined by the hash value and the tag value. Because the lookup table 88 is dual clot table, the age-out command thus contains only the hash value and the tag value without the port number.

In the present invention, the operation status in local side can be shared with the remote side to prevent data from congesting in the buffer. Especially in high-speed network, the buffer may be exhausted by too many data packets. Meanwhile, the continuity and integrity of data transmission can be ensured.

The present invention discloses a network switch comprising a first network switch a second network switch chip. Each network switch chip comprises a high-speed network port and a plurality of network connection ports. The first network switch chip and the second network switch chip are cascaded through the high-speed network ports to form a direct link therebetween. The transmission rate of the high-speed network port is preferably larger than the sum of the transmission rates of the connection ports. Moreover, the operation status of the first network switch chip and the second network switch chip can be updated and shared for each other. The data transmission for all connection ports can be substantially managed as by a single switch chip.

The present invention also discloses a method for cascading network switch chips, wherein a first network switch chip and a second network switch chip are cascaded. Each network switch chip comprises a high-speed network port and a plurality of connection ports. The first network switch chip and the second network switch chip are cascaded through the high-speed network ports to form a direct link therebetween. Therefore, a network switch comprising the first network switch chip and the second network switch chip provides a transmission bandwidth substantially equal to the sum of the plurality of connection ports. Moreover, the operation status of the first network switch chip and the second network switch chip can be updated for and shared between each other. Therefore data transmission for all connection ports can be efficiently managed. Furthermore, the first network switch chip and the second network switch chip can update the lookup table for each other.

The present invention also discloses a local network switch chip cascaded with a remote network switch chip to form a direct link therebetween. The operation status of the local network switch chip can be shared to the remote network switch chip through the direct link and vice versa. The local network switch chip can update the lookup table in the remote network switch chip through the direct link. Moreover, the local network switch chip can send data packets and commands inserting into the data packets in real-time through the direct link.

In comparison with prior art, the network switch according to this invention shares the operation status including the look up table and congestion information through the direct link of high-speed network ports provided in the network switch chips thereof. Thus, cascading two network switch chips enhances the transmission efficiency of the network switch.

Although the present invention has been described with reference to the preferred embodiment thereof, it should be understood that the invention is not limited to the embodiment thereof. Various modifications can be made in view of the above description, which is apparent to persons with ordinary skill in the art. Therefore, all such modifications are intended to be embraced within the scope of the invention as defined in the appended claims.

I claim:

1. A method for cascading network switch chips comprising the following steps:
providing a first network switch chip with a first high-speed network port and a plurality of first connection ports;
providing a second network switch chip with a second high-speed network port and a plurality of second connection ports;
cascading the first high-speed network port and the second high-speed network port to form a direct link therebetween;
Wherein the first network switch chip and the second network switch chip update an operation status for each other through the direct link, and whereby the first network switch chip and the second network switch manage data exchange in response to said operation status.

2. The method for cascading network switch chips as in claim 1, wherein the operation status is a congestion information for the connection port.

3. The method for cascading network switch chips as in claim 2, wherein the network switch chip has flow control over the connection ports thereof according to the congestion information.

4. The method for cascading network switch chips as in claim 1, wherein each of the network switch chips has a lookup table therein and the network switch chips can update the lookup table for each other.

5. The method for cascading network switch chips as in claim 1, wherein the first network switch chip and the second network switch chip send data packets and commands by inserting into the data packets in real-time through the direct link to each other.

6. A network switch chip cascaded to a remote network switch chip through a direct link, the network switch chip reporting an operation status for the remote network switch chip through the direct link and whereby the network switch chip and the remote network switch can manage data exchange therebetween.

7. The network switch chip as in claim 6, wherein the operation status is a congestion information.

8. The network switch chip as in claim 7, wherein the network switch chip performs a flow control over the connection ports thereof according to the congestion information.

9. The network switch chip as in claim 6, wherein the network switch chip can update a lookup table in the remote network switch chip through the direct link.

10. The network switch chip as in claim 6, wherein the network switch chip sends data packet and command mixed into the data packet in real-time way through the direct link.

11. A network switch having
a first network switch chip having a first high-speed network port and a plurality of first connection ports;
a second network switch chip having a second high-speed network port and a plurality of second connection ports;
the first network switch chip and the second network switch chip being connected through the first high-speed network port and the second high-speed network port to form a direct link therebetween;
the network switch providing a transmission rate to the sum of transmission rates of the first connection ports and the second connection ports
wherein the first network switch chip and the second network switch chip update an operation status for each other through the direct link and whereby the first network switch chip and the second network switch can manage data exchange therebetween.

12. The network switch as in claim 11, wherein the operation status is a congestion information of the connection port.

13. The network switch as in claim 12, wherein the network switch chip has flow control over the connection ports thereof according to the congestion information.

14. The network switch as in claim 11, wherein each of the network switch chips has a lookup table therein and the network switch chips can update the lookup table for each other.
